(19) United States
(12) Patent Application Publication
(10) Pub. No.: US 2008/0252131 A1
(43) Pub. Date: Oct. 16, 2008

(54) AUTOMOTIVE VEHICLE SEAT BACK AND METHOD OF MAKING SAME

(76) Inventors: Christoph Warnken, Ingolstadt (DE); Andreas Thiex, Heilbach (DE); Oliver Klier, Rennertshofen (DE); Martin Stanner, Buch am Buchrain (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(21) Appl. No.: 12/056,803

(22) Filed: Mar. 27, 2008

Related U.S. Application Data
(60) Provisional application No. 60/922,864, filed on Apr. 11, 2007.

(51) Int. Cl. A47C 7/02; B23P 11/00

(52) U.S. Cl. 297/452.18; 297/452.38; 29/428

(57) ABSTRACT

A seat back for a rear seat of an automotive vehicle includes a plate and a structural member attached with the plate. The structural member includes a trim channel provided thereon. The plate may include a trim channel provided thereon.

### CROSS-REFERENCE TO RELATED APPLICATION

This application claims the benefit of U.S. Provisional Application No. 60/922,864 filed Apr. 11, 2007.

### BACKGROUND

1. Field of the Invention

The invention relates to automotive vehicle seat backs and methods of making the same.

2. Discussion

Certain seat back configurations for automotive vehicle seats are known. As an example, U.S. Pub. No. 2006/0175887 to Behrens provides a rear backrest frame for a rear backrest component of a vehicle seat. The rear backrest frame includes at least one main plate, one left and one right lateral hat-shaped section extending vertically and one upper and one lower hat-shaped section extending in a transverse direction. The hat-shaped sections are welded to the front surface of the main plate. The rear backrest frame has cushion channels on its lateral edges and its upper and lower edges, for attachment of a cushion and/or cover. The hat-shaped sections are rectilinear in configuration. The lateral hat-shaped sections are welded to the hat-shaped sections that extend in the transverse direction. The lateral cushion channels are formed on the lateral hat-shaped sections.

An another example, U.S. Pat. No. 6,981,748 to Garnweidner et al. provides a rear seat back for a vehicle back seat having a support frame, a rear wall attached to the support frame and a covering channel for anchoring a seat covering. The support frame is formed of extruded profile sections and is constructed in one piece with the covering channel. The rear wall is formed of a substantially flat component.

As yet another example, U.S. Pat. No. 6,260,924 to Jones et al. provides a modular seat back system for a vehicle, including a type-A seat back frame having a center shoulder seatbelt anchorage and a type-B seat back frame having a smaller width. The left edges of the seat back frames are substantially similar in shape and size. The right edges of the seat back frames are substantially similar in shape and size. The symmetry between the edges allows the modular seat back system to form a “40/40 configuration” with two type-B seat back frames in smaller vehicles, a “40/60 configuration” with one type-A and one type-B seat back frame in medium-sized vehicles and a “60/60 configuration” with two type-A seat back frames in larger vehicles. The dual-nature of the center seatbelt anchorage allows the modular seat back system to form a “40/60 configuration” in left-hand-drive versions of a particular vehicle line and a “60/40 configuration” for the right-hand-drive versions.

### SUMMARY

A seat back for a rear seat of an automotive vehicle includes a plate member and a one-piece stamping attached with the plate member. The one-piece stamping includes upper and lower transverse portions and left and right side portions extending between the transverse portions. At least one of the portions includes a trim channel formed therein.

A seat back for an automotive vehicle includes a back panel having a surface and a structural member attached with the back panel for transferring occupant loads to the vehicle. The structural member includes opposing sections at least partially defining a perimeter of the structural member along the surface of the back panel. Each of the opposing sections has a body portion. At least one of the body portions is formed with a radius defining a curved portion of the perimeter and at least one of the opposing sections includes a trim channel formed therein.

A method of manufacturing rear seat backs for automotive vehicles includes forming, with a tool, a first plate member having opposing sides with trim channels provided thereon. The opposing sides are configured to be adjacent first and second sides of a first vehicle. The method also includes forming a first structural member and attaching the first structural member to the first plate member to assemble a first seat back having a first configuration. The method further includes forming, with the tool, a second plate member having opposing sides with trim channels provided thereon. The opposing sides are configured to be adjacent first and second sides of a second vehicle. The method still further includes separating the second plate member into first and second portions. Each of the portions includes one of the opposing sides having a trim channel formed thereon. The method yet further includes forming second and third structural members each including a trim channel, and attaching each of the second and third structural members to one of the first and second portions to assemble a second seat back having a second configuration different from the first configuration.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a front assembly view of a seat back for an automotive seat;

FIG. 2 is a section view of the seat back of FIG. 1 taken along line 2-2 of FIG. 1;

FIG. 3 is a front assembly view of another seat back for an automotive seat;

FIG. 4 is a section view of the seat back of FIG. 3 taken along line 4-4 of FIG. 3; and

FIG. 5 is a schematic view of portions of the seat backs of FIGS. 1 and 2 during various stages of manufacturing.

### DETAILED DESCRIPTION

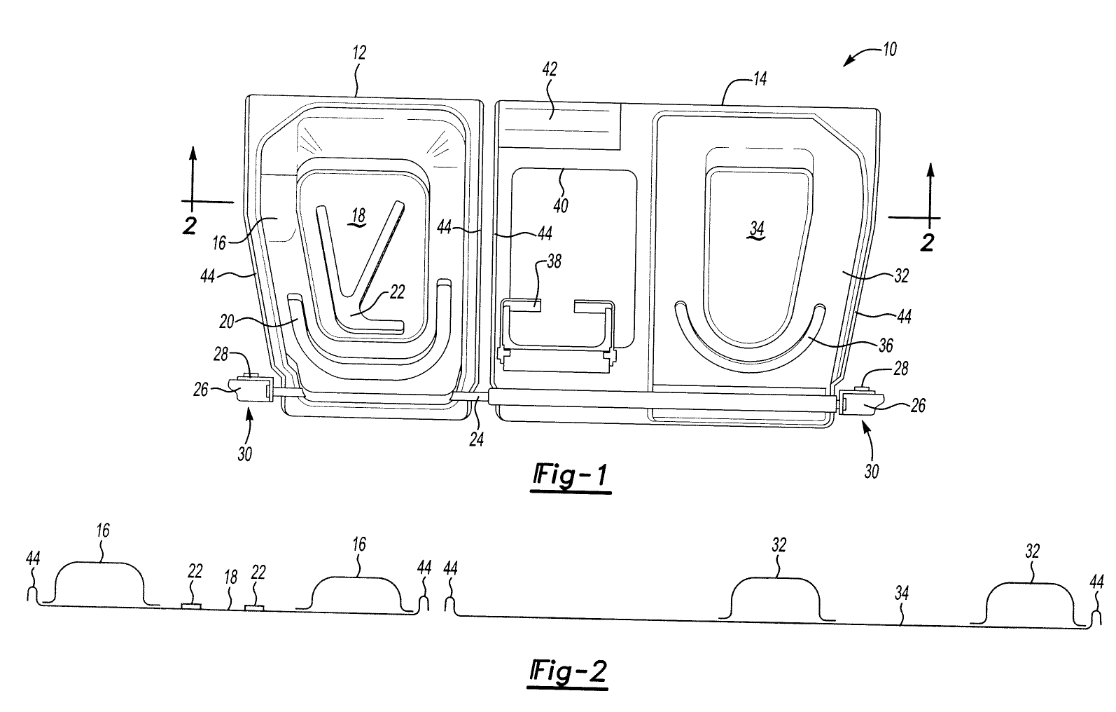

Referring now to FIG. 1, a seat back 10 for an automotive seat includes two sections 12, 14, e.g., a 40%/60% split, to permit an occupant to fold down a portion of the seat back 10 to, for example, provide additional cargo space in a vehicle (not shown).

In the embodiment of FIG. 1, a one-piece stamped structural member 16 is welded with a back panel 18 to form the 40% section 12. In other embodiments, the structural member 16 may comprise a plurality of sections attached together. For example, two L-shaped stampings may be welded together to form a generally rectangular structural member 16. Other configurations, however, are also possible.

The structural member 16 may include a recessed portion 20 to increase its stiffness. The back panel 18 likewise may include a raised portion 22 to increase its stiffness. The shape and location of the recessed portion 20 and raised portion 22 respectively are, of course, dictated by design considerations and may vary depending upon requirements.

As apparent to those of ordinary skill, the structural member 16 is configured to receive a cushion (not shown) through which occupant loads may be transferred to the structural member 16. Such occupant loads are then passed to a beam 24 connected with the structural member 16. The beam 24 transfers these loads to structural members 26 of the vehicle (not shown) via anchor plates 28 provided on respective ends 30 of the beam 24.

In the embodiment of FIG. 1, a one-piece stamped structural member 32 is welded with a back panel 34 to form the 60% section 14. As with the structural member 16, the structural member 32 may comprise a plurality of sections attached together. The structural member 32 is also configured to receive a cushion (not shown) and includes a recessed portion 36 to increase its stiffness. Occupant loads may be transferred from the structural member 32 to the structural members 26 via the beam 24.

An arm rest bracket 38 is hingedly attached with the back panel 34. As known in the art, an arm rest (not shown) attached with the bracket 38 may be moved between a stow position and a use position via the bracket 38. A throughway 40 is further provided in a portion of the back panel 34 adjacent the bracket 38 to permit items to, for example, pass through a trunk of the vehicle (not shown) and into a cabin of the vehicle (not shown) via the throughway 40.

A raised spacer 42 is attached, e.g., welded, with the back panel 34 to provide a contoured backing surface for a trim cover (not shown) of the automotive seat.

Referring now to FIG. 2, the structural members 16, 32 are each hat-shaped in cross-section. In other embodiments, the structural members 16, 32 may have any suitable shape. For example, the structural member 16 may be rectangularly shaped.

The back panels 18, 34 each include trim channels 44 formed on respective lateral sides of the back panels 18, 34. Trim covers (not shown) are attached with the seat back 10 via the trim channels 44. For example, “J-clips” provided on a perimeter of the trim covers may be clipped onto the trim channels 44. Other suitable attachment methods, however, are also possible.

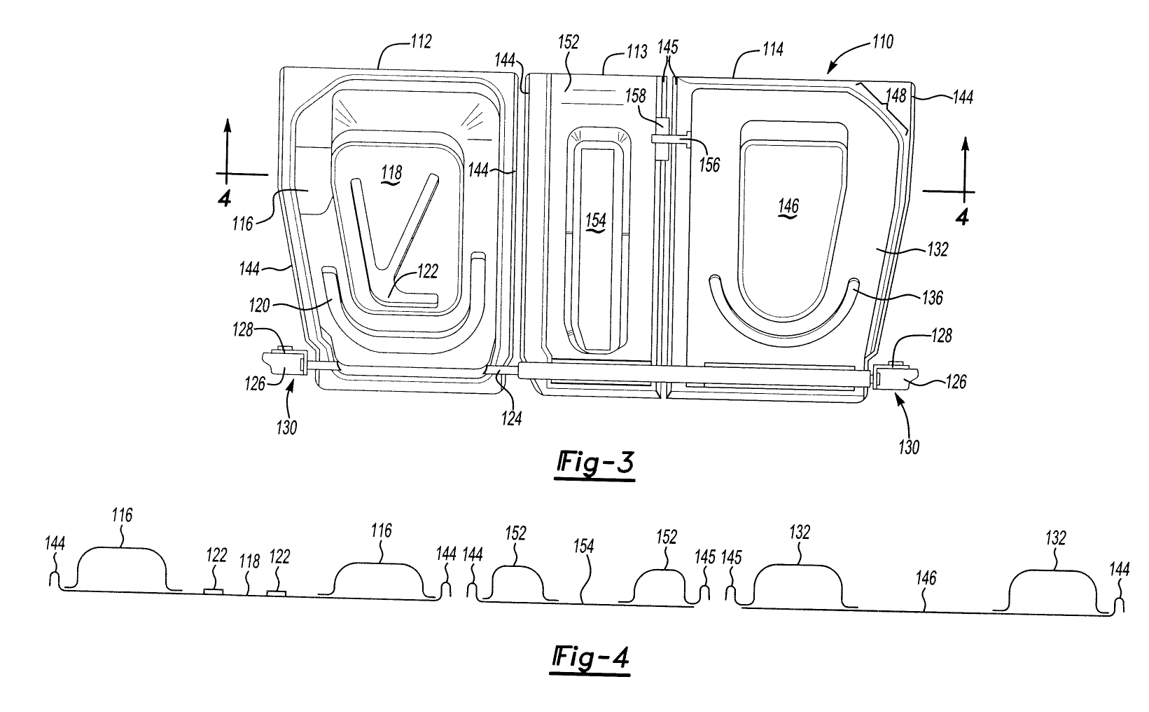

Referring now to FIG. 3, a seat back 110 for an automotive seat (not shown) includes three sections 112, 113, 114, e.g., a 40%/20%/40% split, to permit an occupant to fold down portions of the seat back 110 to, for example, provide additional cargo space in a vehicle (not shown). Numbered elements of FIG. 3 that differ by 100 relative to numbered elements of FIG. 1 have similar, although not necessarily identical, descriptions to the numbered elements of FIG. 1.

In the embodiment of FIG. 3, a one-piece stamped structural member 116 is welded with a back panel 118 to form the 40% section 112. The structural member 116 may include a recessed portion 120 to increase its stiffness. The back panel 118 likewise may include a raised portion 122 to increase its stiffness.

A one-piece stamped structural member 132 is welded with a back panel 146 to form the 60% section 114. As discussed below, the back panel 146 may be formed from the same tool used to form the back panel 34 (FIG. 1).

In the embodiment of FIG. 3, the structural member 132 has four legs that form a generally rectangular shape. Certain portions of the perimeter of the structural member 132 along a surface of the back panel 146 generally follow the outline of the back panel 146. One of the legs of the structural member 146, however, includes a curved, or radiused, portion 148 to accommodate a seat cushion (not shown). In other embodiments, however, the structural member 132 and back panel 146 may have any desired shape. Additionally, the structural member 132 may comprise a plurality of sections attached together.

A one-piece stamped structural member 152 is welded with a back panel 154 to form the 20% section 113. As discussed below, the back panel 154 may be formed from the same tool used to form the back panel 34 (FIG. 1).

In the embodiment of FIG. 3, the structural member 152 has four legs that form a generally rectangular shape. The perimeter of the structural member 152 generally follows the outline of the back panel 154. In other embodiments, however, the structural member 152 and back panel 154 may have any desired shape. Additionally, the structural member 152 may comprise a plurality of sections attached together.

A striker 156 is attached, e.g., mechanically fastened, with the structural member 132. A latching mechanism 158 is attached with the structural member 152. As apparent to those of ordinary skill, the striker 156 and latching mechanism 158 permit an occupant to latch or unlatch the sections 113, 114 so that they may be positioned in the vehicle (not shown) together or separately.

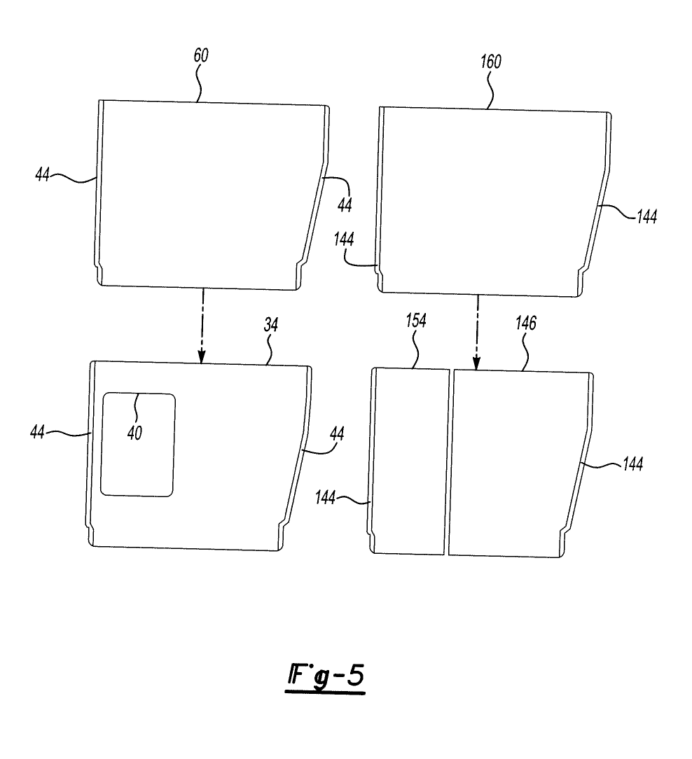

Referring now to FIG. 4, the structural members 116, 132, 152 are each hat-shaped in cross-section. In other embodiments, the structural members 116, 132, 152, however, may have any suitable shape.

Trim channels 144 are provided on lateral sides of the section 112 and formed in the back panel 118. Trim channels 144, 145 are also provided on lateral sides of the sections 113, 114. The trim channels 144 are formed in the back panels 146, 154 respectively, while the trim channels 145 are formed in the structural members 132, 152 respectively.

As illustrated in FIG. 4, the trim channels 144 are formed on respective sides of the back panels 146, 154 that are adjacent, when installed, to a side of the vehicle (not shown). The trim channels 145 are formed on respective sides of the structural members 132, 152 opposite those having the trim channels 144 formed therein. As discussed below, this configuration reduces the number of tools necessary to produce the back panels 34, 146, 154. Other configurations, however, are also possible. For example, the trim channel 145 may be formed around the perimeter of the structural member 132, including the curved portion 149 (FIG. 3). In such embodiments, the back panel 146 need not include the trim channels 144.

As apparent to those of ordinary skill, trim covers (not shown) are attached with the seat back 110 via the trim channels 144, 145. For example, “J-clips” provided on a perimeter of one of the trim covers may be clipped onto the trim channels 144, 145. Other suitable attachment methods, however, are also possible.

Referring now to FIG. 5, plates 60, 160, e.g., steel plates, produced from, for example, the same stamping tool may be further processed to become the back panel 34 for the section 12 or the back panels 146, 154 for the sections 113, 114. The steel plate 60 may punched to create the throughway 40 and then assembled with the structural member 32 (FIG. 1) to create the section 12 (FIG. 1). The steel plate 160 may be cut into two sections and then each section assembled with its respective structural member 152, 132 (FIG. 3) to create the sections 113, 114 respectively (FIG. 3).

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed:

1. A seat back for a rear seat of an automotive vehicle, the seat back comprising:
a plate member; and
a one-piece stamping attached with the plate member, the one-piece stamping including upper and lower transverse portions and left and right side portions extending between the transverse portions, at least one of the portions including a trim channel formed therein.

2. The seat back of claim 1 wherein at least one of the portions has a curvilinear section.

3. The seat back of claim 2 wherein the trim channel is formed along the curvilinear section.

4. The seat back of claim 1 wherein the plate member includes a trim channel formed therein.

5. The seat back of claim 1 wherein at least one of the portions has a hat-shaped cross-section.

6. A seat back for an automotive vehicle comprising:
a back panel having a surface; and
a structural member attached with the back panel for transferring occupant loads to the vehicle, the structural member including opposing sections at least partially defining a perimeter of the structural member along the surface of the back panel, each of the opposing sections having a body portion, at least one of the body portions being formed with a radius defining a curved portion of the perimeter and at least one of the opposing sections including a trim channel formed therein.

7. The seat back of claim 6 wherein the trim channel is formed on the at least one of the body portions being formed with a radius.

8. The seat back of claim 6 wherein the back panel includes a trim channel formed therein.

9. The seat back of claim 6 wherein at least a portion of the structural member is hat-shaped.

10. The seat back of claim 6 wherein the structural member is welded with the back panel.

11. A method of manufacturing rear seat backs for automotive vehicles, the method comprising:
forming, with a tool, a first plate member having opposing sides with trim channels provided thereon, the opposing sides being configured to be adjacent first and second sides of a first vehicle;
forming a first structural member;
attaching the first structural member to the first plate member to assemble a first seat back having a first configuration;
forming, with the tool, a second plate member having opposing sides with trim channels provided thereon, the opposing sides being configured to be adjacent first and second sides of a second vehicle;
separating the second plate member into first and second portions, each of the portions including one of the opposing sides having a trim channel formed thereon;
forming second and third structural members each including a trim channel; and
attaching each of the second and third structural members to one of the first and second portions to assemble a second seat back having a second configuration different from the first configuration.

12. The method of claim 11 wherein attaching the first structural member to the first plate member includes bonding the first structural member to the first plate member.

13. The method of claim 11 wherein attaching the first structural member to the first plate member includes welding the first structural member to the first plate member.

14. The method of claim 11 wherein the second and third structural members are formed via stamping.

15. The method of claim 11 wherein the first plate member is formed via stamping.
